(19) United States
(12) Patent Application Publication
(10) Pub. No.: US 2006/0000314 A1
(43) Pub. Date: Jan. 5, 2006

(54) Kitchen utensil and method of manufacture

(76) Inventor: Mark James Henry, West End (AU)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/881,801

(22) Filed: Jun. 30, 2004

(51) Int. Cl. B21K 11/00; B26B 29/00

(52) U.S. Cl. 76/104.1; 30/342

(57) ABSTRACT

An improved utensil such as a knife is produced by forming integrally with the blade or other working part a tang which ultimately constitutes a substantial portion of the knife-handle including the outer hand-engaged surface of the handle, and providing the tang with an attached cover which constitutes the remainder of the utensil handle.

The present invention relates to a novel construction for a kitchen utensil such as a knife and to a method of manufacturing such an object.

Applicant claims priority with respect to Australian Provisional Application Serial No. 2003903938 filed 29 Jul. 2003 entitled “KNIVES”.

### BACKGROUND OF THE INVENTION

The invention is here specifically disclosed in connection with a utensil having a working part such as a knife blade fixed to a handle. Knives of the applicable type include, without limitation, kitchen knives, butter knives, chef's knives, sporting knives, letter-openers, and bodkins and the like.

The main components of a conventional fixed blade knife are a working part or blade, a tang and a handle. With many traditional knives, the tang is forged with the blade and forms the center spine of the handle, with other handle parts being riveted, pressed, molded, or welded onto both sides of the tang. The traditional knife handles, with two handle halves riveted to the central spine, suffer from loosening of the rivets (a durability problem) and/or opening up of the handle gaps (a hygiene problem).

More modern handle types, like full injection molded handles around smaller internal tangs, suffer from durability problems. Conventional welded all-metal handles involve an excessive number of manufacturing steps, and may suffer from weld joint weaknesses.

The present invention constitutes an improved method of manufacturing a utensil such as a fixed blade knife that eliminates these drawbacks, reduces manufacturing costs, and produces a utensil such as a knife which is stronger than current knives.

### OBJECTS OF THE INVENTION

It is the prime object of the present invention to form a utensil having a tang which constitutes a substantial portion of the utensil handle, particularly including a substantial portion, preferably at least half, of its exterior surface, thus producing strength and reliability at low cost.

It is a further object of the present invention to provide a manufacturing method where the number of manufacturing operations is reduced and the strength of the final product is increased.

It is a still further object of the present invention to provide a knife or similar utensil formed by the described manufacturing method.

Other objects of the present invention will become apparent from the following description.

### SUMMARY OF INVENTION

The blade and tang are formed from a single piece of metal, the tang itself defining a substantial portion of the handle, including a substantial portion of the exterior surface thereof. Optimally, a bolster is formed in said metal piece between said blade and said tang. A second structure in the nature of a cover and preferably comprising the remainder of the handle is then secured to the thus-formed tang in order to complete the handle. The tang is preferably formed with a concave inner surface which may be filled by a body integral with or separate from the cover.

### BRIEF DESCRIPTION OF THE DRAWINGS

The invention will be described in connection with the accompanying drawings in which:

FIG. 1 is a top plan view of a utensil such as a knife manufactured in accordance with the present invention;

FIG. 2 is a top plan view of a strip of metal from which the main portion of the knife is to be formed;

FIG. 3 is a view of the strip of FIG. 2 after a bolster has been formed in it;

FIG. 4 illustrates the formation of a hollow tang in a preliminary stage of manufacture;

FIG. 5 is a view of the embryonic knife of FIG. 4 after the tang has been separated from its surrounding material and a knife blade has been formed on the working part of the utensil and with a cover ready to be moved into place on the tang;

FIG. 6 is a cross-sectional view taken along line 6-6 of FIG. 5 and showing in idealized form the cover in place; and

FIGS. 7 and 8 are cross-sectional views similar to FIG. 6 but showing different cover embodiments, including fillers for the interior of the hollow tang.

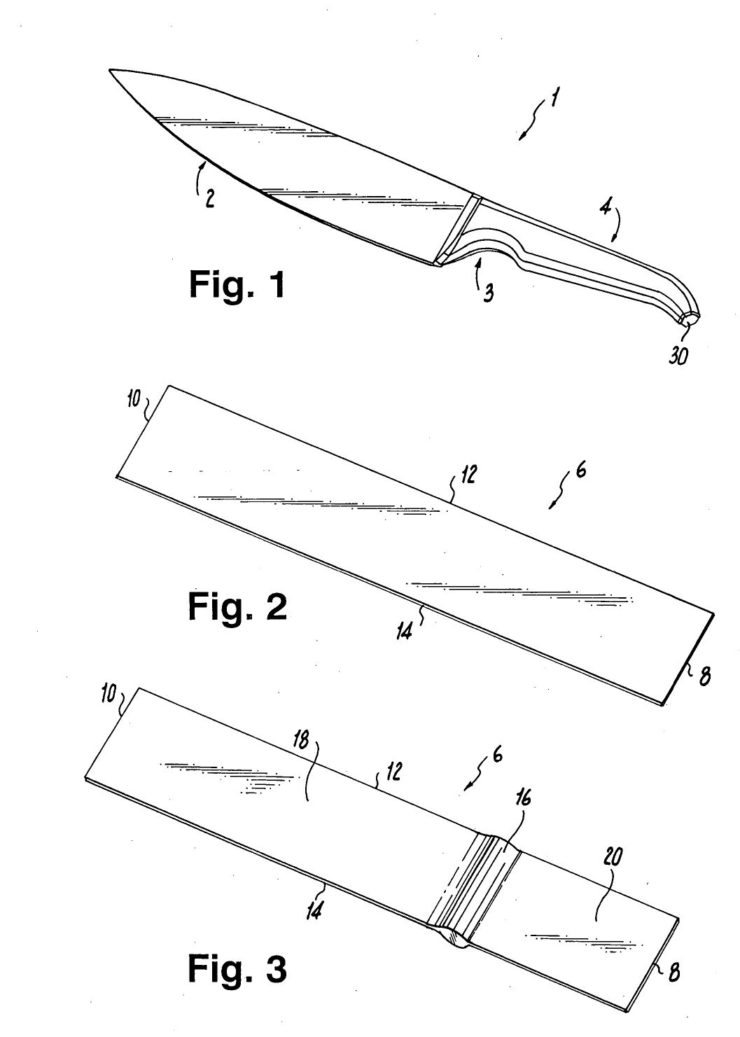

### DESCRIPTION OF THE PREFERRED EMBODIMENTS

A kitchen utensil generally designated 1 is here shown in the form of a knife having a working part or blade 2 and a handle 4. It is formed primarily from a single sheet 6 (see FIG. 2) of an appropriate material such as, particularly in the case of the knife, structural metal of appropriate physical characteristics. The sheet 6 has rearward and forward edges 8 and 10 and side edges 12 and 14. The length and width of the sheet 6 corresponds roughly to the length and width of the desired utensil. The thickness of the sheet 6 is correspondingly chosen to provide the desired physical characteristics of the end product.

As shown in FIG. 3, a bolster 16 may be molded into the knife and serve as a traditional structure between the sections 18 and 20 which will ultimately become the blade 2 and the major portion of the handle 4 of the utensil, respectively. This may be formed by squeezing the material toward the middle to form a solid bulge. The bolster 16 helps to withstand the bending and shearing stresses that will be transferred between the blade 2 and the handle 4. The section 20 will be recognized as the embryonic tang of the knife, but it differs from a conventional tang in extending at least substantially the full distance from the bolster 16 to the rearward edge of the finished product and substantially the full width of the handle 4 of the finished product.

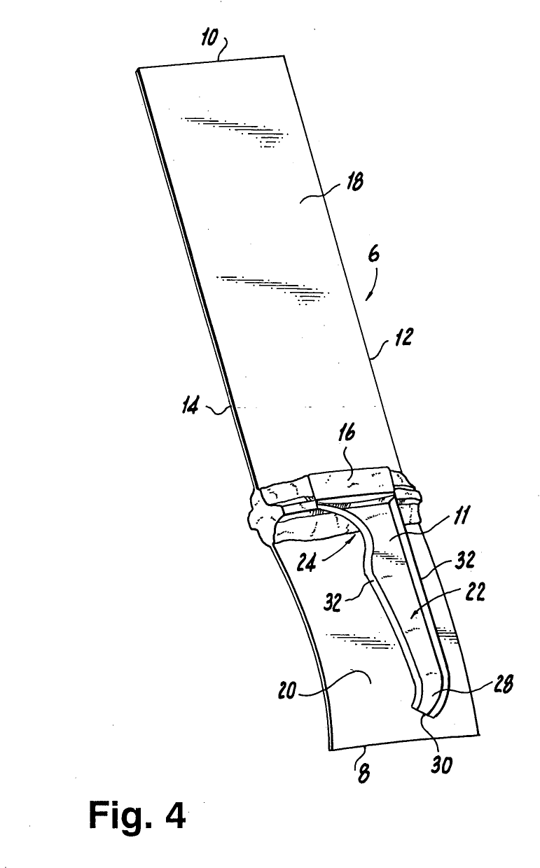

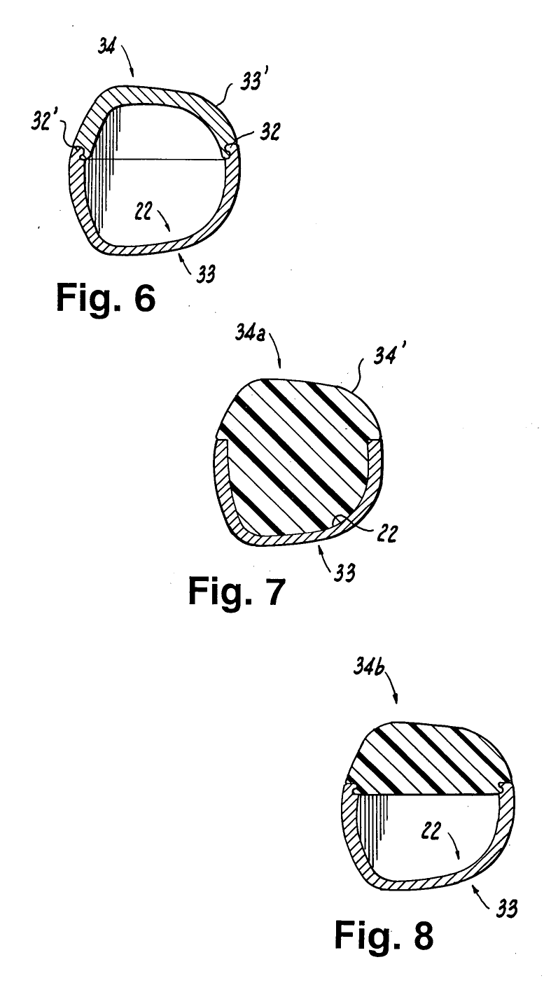

The next step, as shown in FIG. 4, is to form the tang 22 from the section 20 of the sheet 6, which tang, in accordance with the present invention also becomes a major portion, preferably at least half of the handle 4. As here specifically discussed the tang 22 is pressed into the sheet section 20 to form a finger grip region 24, a hand grip region 26, and a base region 28 terminating in the butt 30. The tang 22 is preferably shaped to be concave along substantially its entire length, therefore having upwardly exposed edges 32 surrounding the concave area. When the thus-formed tang 22 is separated from the remainder of the sheet section 20, and when the sheet section 18 is shaped and sharpened in conventional fashion to form a knife blade 2, the unitary structure of claim 5 is produced, with the tang 22 (see FIGS. 6-8) defining at least substantially the full length of the handle 2 with its outer surface 33 defining at least a large portion of the outer surface of the handle constituting as the handle 4. The specific three-dimentional shaping of the tang 22 is so chosen as to enhance its strength.

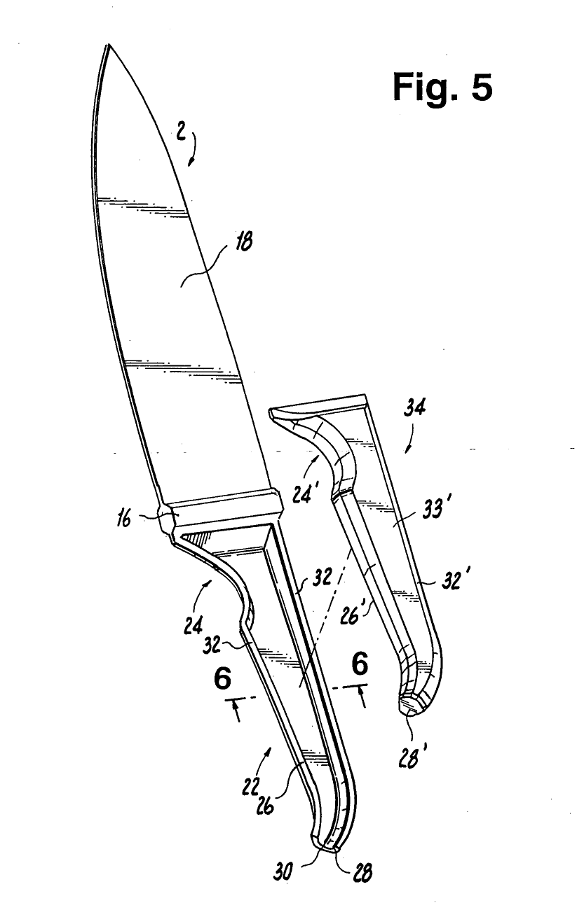

To complete the handle 4 a second structure generally designated 34 (see FIG. 5) is formed of appropriate structural material, which could be the same as the material which forms the tang 22. That second structure 34 may be in effect a mirror image of the tang 22, with its parts corresponding to those of the tang 22 being identified by primed reference numerals. It is designed to be secured to the top of the concave tang 22, thereby closing and sealing the inner concavity of the tang 22, providing an outer handle surface 33¹ which is a continuation of the outer surface 33 of the tang 22, and in effect constituting with the tang 22 the complete handle 4. The securement of the second structure 34 to the tang 22 may be accomplished in any desired fashion, as, for example, by welding along the abutting edges 32 of the tang 22 and the corresponding edges 32 of the second structure or cover 34.

When the second structure 34 is substantially a mirror image of the concave tang 22, the thus-produced handle 4 is hollow, as shown in FIG. 6. Alternatively, the second structure or the cover 34a of the embodiment of FIG. 7 may be a substantially solid body which extends into and fills the inner space of the handle 4 as by injection molding of synthetic material into the concave tang 22. Alternatively, as shown in FIG. 8, the second structure 34b may only partially fill the concavity of the tang 22.

The parts of the utensil are formed of material or materials suitable for the use to which the utensil is to be put, formed and shaped in any way appropriate to the materials involved. The knife structures of FIGS. 2-5 can be made of structural steel of appropriate grade, shaped, as is conventional, by hot or cold forming of sheet or bar stock, or casting to form tang and blade and by machinery to form a cutting edge on the blade all as is conventional. The cover may be similarly constructed and shaped.

By causing the tang to actually become a significant part, and preferably at least half of the externally accessible portion of the handle the manufacturing process is facilitated and made less costly, the number of separate parts that must be made and attached to one another is reduced, the overall ability of the utensil to accommodate large stress when the handle is grasped and the utensil is used is significantly enhanced, and the assembled structure is not vulnerable to hygienic problems.

While only a limited number of embodiments have been here specifically disclosed, it will be apparent that many variations may be made therein without departing from the inventive concepts as defined in the following claims:

I claim:

1. The method of manufacturing a kitchen utensil, such as a knife, said utensil having a working part and a handle, and said method comprising forming, from a single piece of metal, said working part and a tang integrally connected thereto, said tang comprising a substantial part of the exterior of said handle, forming a second structure comprising the remainder of said handle other than said major part, and securing said second structure to said tang to complete said handle.

2. The method of claim 1, in which said tang extends substantially the entire length of said handle and defines a major portion of the exterior surface of said handle.

3. The method of claim 1, in which said tang extends approximately at least 50% of the entire length of said handle and defines at least a 50% portion of the exterior surface of said handle.

4. In the method of any of claims 1-3, forming said tang to be at least in part concave in lateral cross-section, and shaping said second structure so that it covers the concave portion of said tang.

5. In the method of claim 4, a filler substantially filling the concavity in said tang.

6. The method of claim 5, in which said filler is integral with said structure.

7. The method of any of claims 1-3, forming a bolster in said single piece of metal between said working part and said tang.

8. A kitchen utensil such as a knife having a working part and a handle with an exterior handle surface, said utensil comprising a piece of metal defining said working part and an integral tang extending from said working part defining a major portion of said handle, including a major portion of the exterior handle surface, and a second structure secured to said tang to define the remainder of said handle.

9. The kitchen utensil of claim 8, in which the tang defines approximately at least 50% of said handle, including said exterior handle surface.

10. The kitchen utensil of either of claims 8 or 9, in which said tang is at least in part concave in lateral cross-section and in which said second structure covers the concave portion of said tang.

11. The kitchen utensil of claim 10, in which the concavity in said tang is substantially filled with a filler.

12. The kitchen utensil of claim 11, in which said filler is integral with said second structure.

13. The kitchen utensil of either of claims 8 or 9, in which a bolster is formed in said metal piece between said working part and said tang.
